(19) United States
(12) Patent Application Publication
(10) Pub. No.: US 2010/0166916 A1
(43) Pub. Date: Jul. 1, 2010

(54) NUTRITIONAL PRODUCTS

(75) Inventors: Timothy John Lawson, Lancashire (GB); Alan Whitfield, Lancashire (GB); Simon James Lawson, Lancashire (GB)

Correspondence Address: ADAMS INTELLECTUAL PROPERTY LAW, Suite 2350 Charlotte Plaza, 201 South College Street, CHARLOTTE, NC, 28244, US

(73) Assignee: SIS (SCIENCE IN SPORT) LIMITED, Lancashire (GB)

(21) Appl. No.: 12/095,578

(22) PCT Filed: Nov. 29, 2006
(86) PCT No.: PCT/GB2006/004455

§ 371 Date: Oct. 2, 2009

(30) Foreign Application Priority Data
Nov. 30, 2005 (GB) 0524341.5

(51) Int. Cl. A23L 1/305; A23L 1/308; A23L 1/304; A23L 1/302; A23L 1/29; A23L 2/66

(52) U.S. Cl. 426/72; 426/656; 426/74; 426/590; 426/583

(57) ABSTRACT

There are provided nutritional compositions comprising a source of tryptophan and which nutritional compositions further comprise one or more components selected from the group consisting of: a caseinate; magnesium lactate; magnesium gluconate; zinc lactate; and zinc gluconate. Also provided are beverages, food products and methods of consumption.

### FIELD OF THE INVENTION

The present invention relates to nutritional products, particularly to beverages, and to nutritional compositions for use in producing such products.

### BACKGROUND TO THE INVENTION

Athletes and active people undertaking intensive exercise and training may suffer from increased protein oxidation when at rest and this may cause muscle wastage (protein catabolism) and disturbed sleep.

It is therefore known for people to take food supplements in an attempt to minimise such problems. For example supplements, such as a zinc supplement, may be taken before going to bed. However, known supplements may not alleviate the known problems as far as may be desirable. For example, an athlete may still find themselves waking in the night craving protein.

Accordingly, the present invention aims to address at least one disadvantage associated with the prior art whether discussed herein or otherwise.

### SUMMARY OF THE INVENTION

According to the present invention there is provided a nutritional composition comprising a source of tryptophan, wherein the composition comprises a protein providing a source of tryptophan and/or wherein the tryptophan is provided as the free amino acid salt thereof, and which nutritional composition further comprises one or more components selected from the group consisting of: a caseinate; magnesium lactate; magnesium gluconate; zinc lactate; and zinc gluconate.

According to a first aspect of the present invention there is provided a nutritional composition comprising a protein providing a source of tryptophan and which nutritional composition further comprises one or more components selected from the group consisting of: a caseinate; magnesium lactate; magnesium gluconate; zinc lactate; and zinc gluconate.

Preferably, the nutritional composition comprises tryptophan in an amount of at least 0.5% by weight, more preferably at least 0.7% by weight. The nutritional composition may for example comprise tryptophan in an amount of at least 0.8% by weight, for example at least: 0.9%; 1.0; 1.1; 1.2%; 1.3%; 1.4%; or 1.5% by weight. The nutritional composition may for example comprise tryptophan in an amount of between 0.5% and 2% by weight, for example around 1.0% to 1.5% by weight.

Preferably, the nutritional composition comprises a protein providing a source of tryptophan, which protein comprises tryptophan in an amount of at least 2.0% by weight of the protein, and the nutritional composition further comprises one or more components selected from the group consisting of: a caseinate; magnesium lactate; magnesium gluconate; zinc lactate; and zinc gluconate.

Preferably, the nutritional composition comprises a protein providing a source of tryptophan which protein comprises tryptophan in an amount of at least 2.0% by weight of the protein, and the nutritional composition further comprises one or more components selected from the group consisting of: magnesium caseinate; magnesium lactate; magnesium gluconate; zinc lactate; and zinc gluconate.

The tryptophan content may be measured by any suitable means. Such means are well understood by those skilled in the art. One suitable method is by HPLC.

Suitably, said protein providing a source of tryptophan comprises one of two or more proteins in the composition and may thus be referred to herein as the “first protein”.

The nutritional composition may comprise a first protein providing a source of tryptophan and one or more further sources of tryptophan.

The nutritional composition may comprise a first protein providing a source of tryptophan and one or more further proteins which also provide a source of tryptophan.

Suitably, the nutritional composition comprises a first protein providing a source of tryptophan which first protein comprises tryptophan in an amount of at least 2.0% by weight of the protein, and the nutritional composition further comprises one or more components selected from the group consisting of: magnesium caseinate; magnesium lactate; magnesium gluconate; zinc lactate; and zinc gluconate.

Preferably, the nutritional composition comprises a first protein comprising tryptophan in an amount of at least 2.0% by weight and one or more further proteins each comprising tryptophan in an amount of less than 2.0% by weight.

Suitably, the first protein comprises tryptophan in an amount of at least 2.2% by weight, more preferably at least 2.5% by weight, for example at least: 2.6%; 2.7%; 2.8%; 2.9%; 3.0%; 3.1% 3.2%; 3.3%; 3.4%; 3.5%; 3.6%; 3.7%; 3.8%; 3.9%; or 4.0% by weight. Preferably the first protein comprises tryptophan in an amount of between 3.0% and 4.0% by weight, for example around 3.5% by weight.

Suitably, each further protein comprises tryptophan in an amount of no more than 1.8% by weight, more preferably no more than 1.5% by weight, for example no more than: 1.4%; 1.3%; 1.2%; 1.1%; or 1.0% by weight.

Preferably, the nutritional composition comprises a beverage composition for producing a beverage when combined with water.

Preferably, the nutritional composition comprises a solid composition. Suitably, the nutritional composition comprises a granular or preferably a powder composition.

Suitably, the nutritional composition comprises a beverage composition arranged to provide a beverage upon mixing with water, for example tap water. Suitably, the beverage composition is arranged to dissolve and/or form a suspension when mixed with water. Suitably, the beverage composition may be used to produce a cold or hot beverage.

Suitably, the beverage composition is arranged such that between 20 and 60 g of the composition can be combined with between 150 ml and 400 ml of water to produce a beverage. Preferably, the composition is such that between 30 and 50 g, for example around 40 g of the composition can be combined with between 200 ml and 300 ml, for example, around 250 ml of water to produce a beverage.

Preferably, the nutritional composition comprises natural tryptophan.

Suitably the nutritional composition comprises a whey protein, preferably a whey protein concentrate and/or whey protein isolate, providing the source of tryptophan. Suitably, such a protein comprises a first protein of the composition. Suitably, the nutritional composition comprises alpha-lactalbumin (ALA) as the protein providing the source of tryptophan. Suitably, alpha-lactalbumin comprises a first protein of the composition.

Suitably, the nutritional composition comprises the first protein, which provides a tryptophan source, preferably the alpha-lactalbumin (ALA) protein, in an amount of between 10% and 50% by weight.

Suitably, the nutritional composition comprises the first protein in an amount of at least 10% by weight, for example at least: 15%; 20%; 25%; 30%; 35%; 40%; or 45% by weight.

Suitably, the nutritional composition comprises the first protein in an amount of no more than 50% by weight, for example no more than: 45%; 40%; 35%; 30%; 25%; 20%; or 15% by weight.

Preferably, the nutritional composition comprises the first protein in an amount of between 25% and 40% by weight, more preferably between 30% and 35% by weight for example around 33% by weight.

Tryptophan may thus be present in a level such that, in use, it may help the sleep of a person who has consumed the composition and may facilitate the absorption of minerals and/or vitamins from the composition. Suitably, the composition is consumed shortly before going to bed and the vitamins and/or minerals are fed steadily into the body from the gut during sleep.

Preferably the nutritional composition is arranged such that, in use, amino acids are fed steadily into the body of a consumer. Suitably, the composition is consumed shortly before going to bed and the amino acids are fed steadily to the body from the gut during sleep. Thus, consuming the nutritional composition suitably does not create a large spike in plasma amino acid levels which may trigger increased protein oxidation. Accordingly, problems with the body “eating” itself may be avoided. Suitably, it may take up to 8 hours for amino acids from the composition to be absorbed by the body.

Preferably, the nutritional composition comprises one or more further proteins. Preferably, the nutritional composition comprises a caseinate, preferably magnesium caseinate. The caseinate may thus comprise a second protein of the composition. Suitably, the nutritional composition comprises caseinate, preferably magnesium caseinate, in an amount of between 10% and 50% by weight.

Suitably, the nutritional composition comprises caseinate, preferably magnesium caseinate, in an amount of at least 10% by weight, for example at least: 15%; 20%; 25%; 30%; 35%; 40%; or 45% by weight.

Suitably, the nutritional composition comprises caseinate, preferably magnesium caseinate, in an amount of no more than 50% by weight, for example no more than: 45%; 40%; 35%; 30%; 25%; 20%; or 15% by weight.

Preferably, the nutritional composition comprises caseinate, preferably magnesium caseinate, in an amount of between 25% and 40% by weight, more preferably between 30% and 35% by weight for example around 33% by weight.

The caseinate may provide a protein source. Suitably, the caseinate comprises magnesium caseinate and may thus comprise a protein source and a source of magnesium. The caseinate, preferably magnesium caseinate, may provide for slow absorption of proteins. Suitably, this may be a result of the magnesium caseinate clotting in the stomach.

A caseinate, preferably magnesium caseinate, and tryptophan containing protein, preferably alpha-lactalbumin, combination may be slowly released from the gut and may thus be suitable for consumption shortly before sleep. Suitably, this protein combination provides a synergistic effect which may make the combination particularly effective at improving sleep and/or reducing protein cravings.

A caseinate, preferably magnesium caseinate, and tryptophan containing protein, preferably alpha-lactalbumin, combination may provide a desirable ratio of tryptophan to other amino acids.

Suitably, the nutritional composition is substantially free of calcium. Calcium may interfere with the absorption of components of the nutritional composition by the body of a person consuming the composition. In particular it may interfere with the absorption of zinc and/or magnesium.

Suitably, the nutritional composition comprises less than 1% by weight calcium. Preferably, the composition comprises less than 0.5% by weight calcium, for example less than: 0.50%; 0.40%; 0.30%; 0.20%; 0.10%; 0.09%; 0.08%; 0.07%; 0.06%; 0.05%; 0.04%; 0.03%; 0.02%; or 0.01%. The nutritional composition may be completely free of calcium.

Preferably, the nutritional composition comprises magnesium lactate and/or magnesium gluconate. Suitably, the nutritional composition may comprise magnesium gluconate. Preferably, the nutritional composition comprises magnesium lactate.

Suitably, the nutritional composition comprises magnesium lactate and/or magnesium gluconate in an amount of between 0.1% and 10% by weight, more preferably between 1% and 10% by weight.

The nutritional composition may comprise magnesium lactate in an amount of at least 0.1% by weight, for example at least: 0.5%; 1.0%; 1.5%; 2.0%; 2.5%; 3.0%; 3.5%; 4.0%; 4.5%; 5.0%; 5.5%; 6.0%; 6.5%; 7.0%; 7.5%; 8.5%; 9.0%; or 9.5% by weight.

The nutritional composition may comprise magnesium lactate in an amount of no more than 10% by weight, for example no more than: 9.5%; 9.0%; 8.5%; 8.0%; 7.5%; 7.0%; 6.5%; 6.0%; 5.5%; 5.0%; 4.5%; 4.0%; 3.5%; 3.0%; 2.5%; 2.0% 1.5%; 1.0; or 0.5% by weight.

The nutritional composition may comprise magnesium lactate in an amount of between 0.1% and 7.5% by weight, more preferably between 1.0% and 6.0%, for example between 4.0% and 6.0% by weight.

The nutritional composition may comprise magnesium gluconate in an amount of at least 0.1% by weight, for example at least: 0.5%; 1.0%; 1.5%; 2.0%; 2.5%; 3.0%; 3.5%; 4.0%; 4.5%; 5.0%; 5.5%; 6.0%; 6.5%; 7.0%; 7.5%; 8.5%; 9.0%; or 9.5% by weight.

The nutritional composition may comprise magnesium gluconate in an amount of no more than 10% by weight, for example no more than: 9.5%; 9.0%; 8.5%; 8.0%; 7.5%; 7.0%; 6.5%; 6.0%; 5.5%; 5.0%; 4.5%; 4.0%; 3.5%; 3.0%; 2.5%; 2.0% 1.5%; 1.0; or 0.5% by weight.

The nutritional composition may comprise, magnesium gluconate in an amount of between 0.1% and 7.5% by weight, more preferably between 1.0% and 6.0%, for example between 4.0% and 6.0% by weight.

The nutritional composition may comprise magnesium lactate and magnesium gluconate in a combined amount of between 1% and 10% by weight, preferably between 0.1% and 7.5% by weight, more preferably between 1.0% and 6.0%, for example between 4.0% and 6.0% by weight.

Preferably, the nutritional composition comprises zinc lactate and/or zinc gluconate. Suitably, the nutritional composition may comprise zinc gluconate. Preferably, the nutritional composition comprises zinc lactate.

Suitably, the nutritional composition comprises zinc lactate and/or zinc gluconate in an amount of between 0.01% and 1.00% by weight.

The nutritional composition may comprise zinc lactate in an amount of at least 0.01% by weight, for example at least: 0.03%; 0.05%; 0.07%; 0.09%; 0.15%; 0.30%; 0.45%; 0.60%; 0.75%; or 0.90% by weight.

The nutritional composition may comprise zinc lactate in an amount of no more than 1.00% by weight, for example no more than: 0.90%; 0.75%; 0.60%; 0.45%; 0.30%; 0.15%; 0.09%; 0.06%; or 0.03% by weight.

The nutritional composition may comprise zinc lactate in an amount of between 0.01% and 0.50% by weight, more preferably between 0.05 and 0.15% by weight.

The nutritional composition may comprise zinc gluconate in an amount of at least 0.01% by weight, for example at least: 0.03%; 0.05%; 0.07%; 0.09%; 0.15%; 0.30%; 0.45%; 0.60%; 0.75%; or 0.90% by weight.

The nutritional composition may comprise zinc gluconate in an amount of no more than 1.00% by weight, for example no more than: 0.90%; 0.75%; 0.60%; 0.45%; 0.30%; 0.15%; 0.09%; 0.06%; or 0.03% by weight.

The nutritional composition may comprise zinc gluconate in an amount of between 0.01% and 0.50% by weight, more preferably between 0.05 and 0.15% by weight.

The nutritional composition may comprise zinc lactate and zinc gluconate in a combined amount of between 0.01% and 1.00% by weight, preferably between 0.01% and 0.50% by weight, more preferably between 0.05 and 0.15% by weight.

Suitably, the nutritional composition further comprises vitamin B6 (pyridoxine hydrochloride). The nutritional composition may comprise vitamin B6 in an amount of 1% by weight or less, preferably in an amount of between 0.01% and 0.10% by weight.

The nutritional composition may further comprise a protein hydrolysate, preferably a wheat protein hydrolysate, which may be glutamine peptide. Preferably, the nutritional composition comprises glutamine peptide. The nutritional composition may comprise glutamine peptide in an amount of between 1% and 15% by weight, more preferably of between 3% and 10% by weight, for example of around 6% by weight.

The nutritional composition may further comprise soluble fibre. Suitably, the soluble fibre comprises a fructo-oligosaccharide. The nutritional composition may comprise a soluble fibre in an amount of between 5% and 15% by weight, more preferably between 8% and 12% by weight, for example around 10% by weight.

The nutritional composition may further comprise a saccharide, preferably a monosaccharide, for example fructose. The nutritional composition may comprise a saccharide in an amount of between 3% and 15% by weight, more preferably between 6% and 12% by weight, for example around 9% by weight.

The nutritional composition may further comprise a gum, preferably guar gum and/or xanthan gum. The nutritional composition may comprise gum in an amount of less than 5% by weight, more preferably in an amount of between 0.5% and 1.5% by weight.

The nutritional composition may further comprise a stabiliser, preferably a phospholipid, for example lecithin. The nutritional composition may comprise a stabiliser in an amount of less than 5% by weight, more preferably in an amount of between 0.5% and 1.5% by weight.

The nutritional composition may comprise a source of choline. The choline source may comprise lecithin.

Suitably, the nutritional composition comprises a stable combination of proteins, vitamins and minerals.

The nutritional composition may further comprise flavouring agents. The flavouring agents may be present in an amount of 5% by weight or less.

The nutritional composition may further comprise a source of tryptophan provided as the free amino acid or a salt thereof.

The nutritional composition may consist of the components described hereinbefore.

The nutritional composition may comprise zinc lactate, magnesium lactate and zinc gluconate together with alpha-lactalbumin. This may provide a stable means to fortify alpha-lactalbumin with zinc and magnesium.

The nutritional composition may comprise magnesium caseinate and/or other caseinate and/or magnesium gluconate together with alpha-lactabumin. This may provide a means to make a high tryptophan beverage that allows protein to be slowly released from the gut and may thus be suitable for night-time use. The composition may further comprise protein hydrolysate and/or gum which may increase glutamine levels or further control gastric emptying respectively.

The nutritional composition may comprise a tryptophan containing protein, such as alpha-lactalbumin, together with vitamin B6, zinc lactate and/or gluconate and magnesium lactate and/or gluconate. This may provide a synergistic combination of tryptophan, zinc and magnesium. The composition may further comprise soluble fibres, preferably fructo-oligosaccharides.

According to a second aspect of the present invention there is provided a nutritional composition comprising a source of tryptophan provided as the free amino acid or a salt thereof, and which nutritional composition further comprises one or more components selected from the group consisting of: a caseinate; magnesium lactate; magnesium gluconate; zinc lactate; and zinc gluconate.

The nutritional composition of the second aspect may comprise, where suitable, any of the features, including components and amounts, of the nutritional composition of the first aspect.

The nutritional composition may further comprise a protein providing a source of tryptophan, as defined in relation to the nutritional composition of the first aspect. It may comprise more than one protein providing a source of tryptophan.

The tryptophan content of the nutritional composition of the second aspect is preferably as defined in relation to the first aspect. Where one or more further sources of tryptophan is present, for example a protein providing a source of tryptophan, the content of tryptophan present in the composition refers to the total content of tryptophan, from all sources.

According to a third aspect of the present invention there is provided a beverage comprising water, a source of tryptophan, wherein the beverage comprises a protein providing a source of tryptophan and/or wherein the tryptophan is provided as the free amino acid or salt thereof, and which beverage further comprises one or more components selected from the group consisting of: a caseinate; magnesium lactate; magnesium gluconate; zinc lactate; and zinc gluconate.

Suitably, there is provided a beverage comprising water, a protein providing a source of tryptophan and which beverage further comprises one or more components selected from the group consisting of: a caseinate; magnesium lactate; magnesium gluconate; zinc lactate; and zinc gluconate.

Preferably, the beverage comprises tryptophan in an amount of at least 0.05% by weight, more preferably at least 0.07% by weight. The nutritional composition may for example comprise tryptophan in an amount of at least 0.08% by weight, for example at least: 0.09%; 0.10; 0.11; 0.12%; 0.13%; 0.14%; 0.15%; 0.16; 0.17; 0.18; 0.19; or 0.20% by weight. The nutritional composition may for example comprise tryptophan in an amount of between 0.05% and 0.30% by weight, for example around 0.10% to 0.20% by weight.

Preferably, the beverage comprises a protein providing a source of tryptophan, which protein comprises tryptophan in an amount of at least 2.0% by weight of the protein, and the beverage further comprises one or more components selected from the group consisting of: a caseinate; magnesium lactate; magnesium gluconate; zinc lactate; and zinc gluconate.

Suitably, said protein providing a source of tryptophan comprises one of two or more proteins in the beverage and may thus be referred to herein as the “first protein”.

Suitably, the beverage comprises a first protein providing a source of tryptophan which first protein comprises tryptophan in an amount of at least 2.0% by weight of the protein.

Suitably, the first protein comprises alpha-lactalbumin.

Suitably, the beverage comprises water and a nutritional composition comprising a protein providing a source of tryptophan and which nutritional composition further comprises one or more components selected from the group consisting of: a caseinate; magnesium lactate; magnesium gluconate; zinc lactate; and zinc gluconate.

Suitably, the beverage is produced by combining water and a nutritional composition comprising a beverage composition according to the first aspect.

Suitably, the beverage comprises water in an amount of between 75% and 95% by weight, more preferably between 80% and 90% by weight, for example around 87% by weight.

Suitably, the beverage comprises nutritional composition in an amount of between 5% and 25% by weight, more preferably between 10% and 20% by weight, for example around 13% by weight.

Suitably, the beverage comprises a first tryptophan containing protein in an amount of between 1% and 10% by weight, more preferably between 2% and 7% by weight, for example around 4% by weight.

Suitably the beverage comprises a caseinate, preferably magnesium caseinate, in an amount of between 1% and 10% by weight, more, preferably between 2% and 7% by weight, for example around 4% by weight.

Suitably, the beverage comprises zinc lactate and or gluconate in an amount of between 0.001% and 0.150% by weight, more preferably between 0.005% and 0.020% by weight.

Suitably, the beverage comprises magnesium lactate and or gluconate in an amount of between 0.01% and 1.00% by weight, more preferably between 0.10% and 0.75% by weight.

Suitably, the beverage comprises any feature as described in relation to the beverage composition of the first aspect.

Suitably, the beverage may be used as a food supplement.

According to a fourth aspect of the present invention there is provided a food product comprising a source of tryptophan, wherein the product comprises a protein providing a source of tryptophan and/or wherein the tryptophan is provided as the free amino acid or salt thereof, and which food product further comprises one or more components selected from the group consisting of: a caseinate; magnesium lactate; magnesium gluconate; zinc lactate; and zinc gluconate.

Suitably, there is provided a food product comprising a protein providing a source of tryptophan and which food product further comprises one or more components selected from the group consisting of: a caseinate; magnesium lactate; magnesium gluconate; zinc lactate; and zinc gluconate.

Preferably, the food product comprises a protein providing a source of tryptophan, which protein comprises tryptophan in an amount of at least 2.0% by weight of the protein, and the food product further comprises one or more components selected from the group consisting of: a caseinate; magnesium lactate; magnesium gluconate; zinc lactate; and zinc gluconate.

Suitably, said protein providing a source of tryptophan comprises one of two or more proteins in the food product and may thus be referred to herein as the “first protein”.

Suitably, the food product comprises a first protein providing a source of tryptophan which first protein comprises tryptophan in an amount of at least 2.0% by weight of the protein.

Suitably, the first protein comprises alpha-lactalbumin.

The food product may comprise a food bar. Suitably, the food product comprises a substantially solid food product.

The food product may comprise a protein product, for example a dairy free protein product.

The food product may comprise a nutritional composition according to the first aspect.

Suitably, the food product may comprise any feature as described in relation to the nutritional composition of the first aspect.

According to a fifth aspect of the present invention there is provided a method of consuming protein and vitamins and/or minerals, said method comprising consuming a beverage according to the third aspect and/or a food product according to the fourth aspect within 1 hour of going to sleep.

### DETAILED DESCRIPTION OF PREFERRED EMBODIMENTS

The present invention will now be illustrated by way of example.

### Example 1

A nutritional composition was prepared according to the formulation shown in Table 1.

TABLE 1

| Component | Amount/g | |
|---|---|---|
| Magnesium Caseinate | 7000 | |
| Whey Protein Concentrate | 6900 | |
| Glutamine Peptide | 1200 | |
| Soluble Fibre | 2100 | |
| Guar Gum | 150 | |
| Xanthan Gum | 40 | |
| Lecithin | 200 | |
| Fructose | 1900 | |
| Magnesium Lactate | 1000 | |
| Zinc Lactate | 25 | |
| Pyridoxine Hydrochloride | 4.8 | |
| Flavouring agents (salt, | 521 | |
| sucralose, vanilla flavouring, | | |
| vanilla) | | |
| TOTAL | 21040.8 | g |

The whey protein concentrate comprised alpha-lactalbumin and was thus high in tryptophan. This protein comprised approximately 33% by weight of the composition.

The composition comprised a substantially dry powder. The composition was prepared by first passing each of the components through a 1.0 mm sieve to improve uniformity. The components were then weighed out according to the formulation. The components were then combined in a rotary blender and mixed for four minutes to provide a homogenous composition. That composition was then split into 40 g portions and packaged.

### Example 2

A beverage was produced by combining a 40 g portion of the nutritional composition of Example 1 with 260 ml of water. The composition was poured into a glass of water and then mixed by stirring. This produced a homogenous and palatable beverage.

Without wishing to be bound by theory the benefits which the components of this beverage may exhibit are described briefly below.

Magnesium Caseinate may provide a good source of protein and supply magnesium, but may also clot in the stomach to slow the absorption of the proteins which may be over as much as eight hours, for example overnight/during sleep.

Alpha-lactalbumin may provide a source of protein high in tryptophan. Tryptophan may promotes sleep and may help with the absorption of zinc. Alpha-lactalbumin may be rapidly absorbed when taken in isolation but this may be controlled by its combination with other components of the beverage which may thus promote night time nitrogen balance.

Athletes in hard training may deplete their zinc levels and low zinc levels may be associated with low levels of insulin and insulin growth factor, low testosterone and depressed immune function. Zinc Lactate and zinc gluconate (which may be used in alternative embodiments, not illustrated) may provide sources of zinc.

Athletes in hard training may deplete their magnesium levels and low magnesium levels may be associated with low levels of insulin and insulin growth factor, and low testosterone. Magnesium lactate and magnesium gluconate (which may be used in alternative embodiments, not illustrated) may provide sources of magnesium.

### Guar Gum

Guar gum may help to control the absorption rate of the proteins and/or other components and may work in conjunction with the caseinate and fructo-oligosaccharides.

Fructo-oligosaccharides (soluble fibre) may work in conjunction with the caseinate and guar gum to control absorption. It may also increase the absorption of zinc and/or magnesium. Fructo-oligosaccharides may also promote good health, especially immune function, by preferentially feeding the good bacteria in the gut.

Lecithin may be a useful stabiliser in the beverage but may also provide a source of choline that is often depleted during exercise.

Glutamine stores may be depleted in athletes and sportspeople. Glutamine peptide may increases the glutamine content of the protein in the beverage. The glutamine may work synergistically with zinc to help promote immune function.

Athletes may be depleted in vitamin B6 because it is a co-factor in energy producing metabolic pathways. Vitamin B6 may prevent the formation of homocysteine from methionine.

The inclusion of vitamin B6 may thus alleviate this and it may work synergistically with other components in the beverage.

The tryptophan (from alpha-lactalbumin), vitamin B6, zinc lactate (or alternatively gluconate) and magnesium lactate (or alternatively gluconate) and fructo-oligosaccharides of a preferred beverage composition may work synergistically to improve absorption and control the rate of absorption of one another such that they are absorbed slowly over night.

### Example 3

A nutritional composition was prepared according to the formulation shown in Table 2.

TABLE 2

| Component | Amount/g | |
|---|---|---|
| Lecithin | 200 | |
| Magnesium Lactate | 1400 | |
| Magnesium Gluconate | 400 | |
| Zinc Lactate | 25 | |
| Zinc Gluconate | 5 | |
| Sucralose | 10 | |
| Sodium Chloride | 10 | |
| Xanthan Gum | 40 | |
| Guar Gum | 300 | |
| Vitamin B6 | 4.8 | |
| Whey Concentrate (High Tryp) | 13900 | |
| Fructose | 4000 | |
| Vanilla Flavouring | 400 | |
| Vanilla | 100 | |
| TOTAL (powder) | 20794.8 | g |

### Example 4

A nutritional composition was prepared according to the formulation shown in Table 3.

TABLE 3

| Component | Amount/g | |
|---|---|---|
| Lecithin | 200 | |
| Magnesium Lactate | 1400 | |
| Magnesium Gluconate | 300 | |
| Sucralose | 10 | |
| Sodium Chloride | 10 | |
| Xanthan Gum | 40 | |
| Guar Gum | 300 | |
| Vitamin B6 | 4.8 | |
| Calcium Caseinate | 7000 | |
| Whey Concentrate (High Tryp) | 6900 | |
| Glutamine Peptide | 1200 | |
| Fructose | 4000 | |
| Vanilla Flavouring | 400 | |
| Vanilla | 100 | |
| TOTAL (powder) | 21864.8 | g |

### Example 5

A nutritional composition was prepared according to the formulation shown in Table 4.

TABLE 4

| Component | Amount/g | |
|---|---|---|
| Lecithin | 200 | |
| Magnesium Lactate | 1400 | |
| Magnesium Gluconate | 400 | |
| Zinc Lactate | 25 | |
| Zinc Gluconate | 5 | |
| Sucralose | 10 | |
| Sodium Chloride | 10 | |
| Xanthan Gum | 40 | |
| Guar Gum | 300 | |
| Vitamin B6 | 4.8 | |
| Fructo-Oligosaccharides | 2100 | |
| Whey Concentrate (High Tryp) | 13900 | |
| Fructose | 4000 | |
| Vanilla Flavouring | 400 | |
| Vanilla | 100 | |
| TOTAL (powder) | 22894.8 | g |

The nutritional compositions of examples 3, 4 and 5 may be combined to produce a beverage in a method similar to that described in example 2.

It will be appreciated that preferred embodiments of the present invention may provide a nutritional composition and/or beverage and/or food product which may promote to restful sleep, improve the health and performance of active people and/or improve immune and/or hormonal function and which may also be stable. Such compositions and/or beverages and/or food products may enable the slow release of proteins into the body and/or enable the delivery of supplementary minerals such as zinc and magnesium. Such compositions and/or beverages and/or food products may thus allow effective supplementation with protein and/or vitamins and/or minerals during sleep, which may be the best time for zinc and magnesium supplementation, and may minimise or prevent protein catabolism.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A nutritional composition, comprising:
a source of tryptophan, wherein the source of the tryptophan is one or more of a protein and the free amino acid or salt thereof; and
one or more components selected from the group consisting of: a caseinate; magnesium lactate; magnesium gluconate; zinc lactate; and zinc gluconate.

2-4. (canceled)

5. A composition according to claim 1, wherein the composition comprises tryptophan in an amount of at least 0.5% by weight.

6. A composition according to claim 1, wherein the protein provides the source of tryptophan, which protein comprises tryptophan in an amount of at least 2.0% by weight of the protein.

7. (canceled)

8. A composition according to claim 1, wherein the composition comprises the protein providing the source of tryptophan, wherein the protein comprises one of two or more proteins in the composition.

9. A composition according to claim 8, wherein the nutritional composition comprises a first protein comprising tryptophan in an amount of at least 2.0% by weight and one or more further proteins each comprising tryptophan in an amount of less than 2.0% by weight.

10. A composition according to claim 1, wherein the nutritional composition comprises a beverage composition for producing a beverage when combined with water.

11. A composition according to claim 1, wherein the protein comprises a whey protein.

12. A composition according to claim 1, wherein the protein comprises alpha-lactalbumin (ALA).

13. A composition according to claim 1, wherein the nutritional composition comprises a first protein, which provides a tryptophan source in an amount of between 10% and 50% by weight.

14. A composition according to claim 1, wherein the composition comprises caseinate, in an amount of between 10% and 50% by weight.

15. A composition according to claim 14 wherein the caseinate is magnesium caseinate.

16. A composition according to claim 1, wherein the nutritional composition is substantially free of calcium.

17. (canceled)

18. A composition according to claim 1, wherein the composition comprises magnesium lactate and/or magnesium gluconate in an amount of between 0.1% and 10% by weight.

19. (canceled)

20. A composition according to claim 1, wherein the nutritional composition comprises zinc lactate and/or zinc gluconate in an amount of between 0.01% and 1.00% by weight.

21. A composition according to claim 1, wherein the nutritional composition further comprises vitamin B6 (pyridoxine hydrochloride).

22. A composition according to claim 1, wherein the nutritional composition further comprises a protein hydrolysate.

23. A composition according to claim 1, wherein the composition comprises glutamine peptide.

24. A composition according to claim 1, wherein the composition comprises soluble fibre.

25. A composition according to claim 1, wherein the composition comprises a fructo-oligosaccharide.

26. A composition according to claim 1, wherein the composition comprises a saccharide.

27. A composition according to claim 1, wherein the composition comprises a gum.

28. A composition according to claim 1, wherein the composition comprises a stabilizer.

29. A composition according to claim 1, wherein the composition comprises a source of choline.

30. A beverage comprising water, a source of tryptophan, wherein the beverage comprises a protein providing a source of tryptophan and/or wherein the tryptophan is provided as the free amino acid or salt thereof, and which beverage further comprises one or more components selected from the group consisting of: a caseinate; magnesium lactate; magnesium gluconate; zinc lactate; and zinc gluconate.

31. (canceled)

32. (canceled)

33. A food product comprising a source of tryptophan, wherein the product comprises a protein providing a source of tryptophan and/or wherein the tryptophan is provided as the free amino acid or salt thereof, and which food product further comprises one or more components selected from the group consisting of: a caseinate; magnesium lactate; magnesium gluconate; zinc lactate; and zinc gluconate.

34-36. (canceled)
